(19) United States
(12) Patent Application Publication
(10) Pub. No.: US 2019/0282447 A1
(43) Pub. Date: Sep. 19, 2019

(54) METERING PIPETTE

(71) Applicant: Claus EZINGER, Zell am See (AU)

(72) Inventor: Claus EZINGER, Zell am See (AT)

(21) Appl. No.: 16/347,054

(22) PCT Filed: Sep. 7, 2017
(86) PCT No.: PCT/EP2017/072506

§ 371 Date: May 2, 2019

(30) Foreign Application Priority Data
Sep. 28, 2016 (DE) 10 2016 118 288.5

(51) Int. Cl. A61J 7/00

(52) U.S. Cl. CPC A61J 7/0053

(57) ABSTRACT

The invention relates to a metering pipette (1) which comprises a sleeve (2) for receiving a medium to be dispensed, wherein a plunger (3) can be slid longitudinally into said sleeve (2), and characterised in that at least one dispensing opening (4) for in the medium contained in the sleeve (2) is positioned so as to deviate from the longitudinal axis of the sleeve (2) and the longitudinal movement of the plunger (3) within said sleeve (2).

The invention relates to a metering pipette for a medium, such as for example a liquid, a gel or the like, as per the features of the preamble of claim 1.

Metering pipettes of this type are known. They have a sleeve that forms a space for receiving a medium to be dispensed. A plunger (also referred to as a piston) is longitudinally slidable in the sleeve and seals off the space for receiving the medium at a rear end of the sleeve. At the opposite front end, a dispensing opening via which the medium is dispensed when the plunger is moved into the sleeve is provided centrally on the longitudinal axis of the sleeve. Metering devices of this type are also referred to colloquially as syringes or metering syringes.

In the case of this known metering pipette (“syringe”), the central, forwardly directed outlet for the medium to be dispensed has the disadvantage that, when administered orally, the contents of the sleeve are sprayed directly into the pharynx of the person, in particular if the plunger is pushed into the sleeve with excessive pressure or excessive speed. This can lead to choking and vomiting. For infants, children and elderly persons, in particular, this directly sprayed jet of medium is highly unpleasant and often leads to refusal to take the medium. In the worst case, health impairments or even more serious health problems can occur as a result of choking or vomiting.

The object of the invention is therefore to provide a metering pipette that avoids the disadvantages described above.

The object is attained by the features of claim 1.

According to the invention, is it provided that at least one dispensing opening for the medium situated in the sleeve is provided in the sleeve at a location offset from the longitudinal axis of the sleeve and the longitudinal movement of the plunger. This means that the sleeve no longer has, as is known in the prior art, a central, forwardly directed opening for dispensing the medium, but rather that at least one dispensing opening is oriented in a manner offset from the longitudinal axis of the sleeve and the movement direction of the plunger. Preferably, the at least one dispensing opening is at an end wall, in particular at a front end wall, of the sleeve opening approximately transversely with respect to the movement direction of the plunger.

In one refinement of the invention, it is provided that the front end of the sleeve is completely closed and the at least one dispensing opening is directly adjacent the front end wall. This means that the front end of the sleeve is closed and no longer has a central dispensing opening. At least one dispensing opening for dispensing the medium is provided rearward of of the end wall of the sleeve, which end wall is remote from the plunger. Consequently, the metering pipette can be inserted in such a way into the region in which the medium is to be dispensed from the sleeve that the at least one dispensing opening also reaches regions that are otherwise not readily accessible. For example, by way of the arrangement of the at least one dispensing opening directly adjacent the end wall, the sleeve can be inserted into the mouth of a patient and the pharynx reached, in order that, there, the medium can be dispensed (administered) laterally from the sleeve by pushing of the plunger. This means that, by way of the metering pipette according to the invention, it is possible not only to reach regions for the administration that are otherwise not readily accessible, but also advantageously for administration that is gentle and that the patient does not find uncomfortable to be realized.

In one refinement of the invention, it is provided that at least two dispensing openings are in the front region of the sleeve. Besides a single dispensing opening, it is also possible to have two or more than two dispensing openings at the same height or at different heights in the longitudinal extent of the sleeve for dispensing the medium. Owing to the lateral orientation of the at least one dispensing opening (a single dispensing opening) or of the two dispensing openings (exactly two or exactly three or even more dispensing openings), the medium is no longer sprayed directly into the pharynx but in the direction of the cheeks, more precisely in the direction of the cheek inner side, with the result that choking, vomiting or the like is prevented in an effective manner. The lateral orientation of the at least one dispensing opening results in the medium to be dispensed being orally distributed in a diffuse manner, and after this medium has been dispensed, the person can, in a targeted manner, further distribute it in the mouth and take it in by swallowing. Furthermore, it is possible via the at least two dispensing openings for a larger volume of the medium to be dispensed than would be possible only sleeve with one dispensing opening. The front region is to be understood as meaning that region that forms the half of the longitudinal extent of the tube immediately rearward of the front-end wall.

In one refinement of the invention, it is provided that the at least two dispensing openings in the front region of the sleeve are directly adjacent the end wall. In this way too the advantage is obtained with a relatively large dispensing volume (in relation to a single dispensing opening) that regions that are otherwise not readily accessible are reached.

In one refinement of the invention, it is provided that the at least two dispensing openings are positioned in the sleeve in a symmetrical manner (about the longitudinal axis of the sleeve). Consequently, a uniform distribution of the medium from the sleeve at the dispensing position is advantageously achieved. The geometry of the sleeve according to the invention is preferably ergonomically formed in a semicircular manner, wherein in particular, when used, a round side of the sleeve is surrounded by the upper lip of the patient, whereas the straight lower side bears on the lower lip. Alternatively, a uniformly oval or round sleeve is also conceivable.

Preferably, use is made of the metering pipette according to the invention for the oral administration of media, in particular medicines, with human patients. However, this type of metering pipette may also be used in the field of veterinary medicine and in the field of nutritional supplements.

The sleeve and the plunger may advantageously consist of a plastic material since, with this material, hygiene and, where necessary, sterility can be realized very well. Other materials are also usable, however, according to the field of use. If these two parts of the metering pipette consist of plastic, they are produced for example in a spraying or injection molding process, whereby large quantities can be realized in a cost-effective manner. This is important if the metering pipette is a disposable article that, in particular for health reasons, may be used only once. Metering pipettes are often used, as an alternative to single use, generally not only once but over the duration of a handling cycle. Moreover, metering pipettes may, as required, be washed (even in a dishwasher) and re-used.

The sleeves of the metering pipettes according to the invention are preferably, but not exclusively, produced from polypropylene (PP) or polyethylene (PE). The plungers are preferably, but not exclusively, composed of polypropylene (PP) or polystyrene (PS). All the materials used may, but do not have to, have a food grade or pharma grade certificate and should, ideally, be assembled exclusively in clean rooms of class ISO 8, 7, 6 or 5 and, likewise ideally, be produced only by producers certified according to ISO 17358 and ISO 13485.

The metering pipettes according to the invention may, but do not have to, have a round, cylindrical shape of the sleeve, use also being able to be made however of oval or rectangular and also ergonomically half-round shapes of the sleeve.

It is also the case that the at least one, preferably the two, lateral outlet openings may, but do not have to, be oriented obliquely toward the rear into the palate. Alternatively, it is also possible for virtually or completely horizontal openings to be used.

The metering pipette is assembled after the production of its sleeve and its plunger, wherein the interior of the sleeve can be filled with the medium to be dispensed. In this case, one end of the plunger rearwardly seals off the interior of the sleeve, and at the opposite front end of the sleeve the at least one dispensing opening is provided, albeit initially closed off. It is only when the plunger is moved (pushed) into the sleeve that the closure of the at least one dispensing opening is opened and the medium can be dispensed. Alternatively, it is conceivable that, after manufacture, the metering pipette has an empty sleeve interior that is filled (once or multiple times, completely or only partially) by a user of the metering pipette. For this purpose, it is conceivable for the front end of the sleeve to be dipped into a container that contains the medium to be dispensed at a later stage, with the result that, when the plunger, which was initially pushed arranged completely into the sleeve, is pulled out, a negative pressure is generated and the medium is sucked into the interior of the sleeve from the container. This process can be assisted in that, with the aspiration of the medium from the container, for example a bottle, the metering pipette is inserted into an inner opening of a reduction ring (also in the form of a reduction plug, composed of PE for example), and the outer surface of this ring fits with the inner surface in the neck of the bottle. This reduction ring is produced for example from an elastically deformable material. It may consist of solid material, and it is alternatively conceivable for it to have an annular shape in order that the shape of the inner periphery of the container (for example the inner surface of the neck of the bottle) fits complementarily with the outer surface of the metering pipette in the region of the front end thereof for the purpose of sucking in the medium.

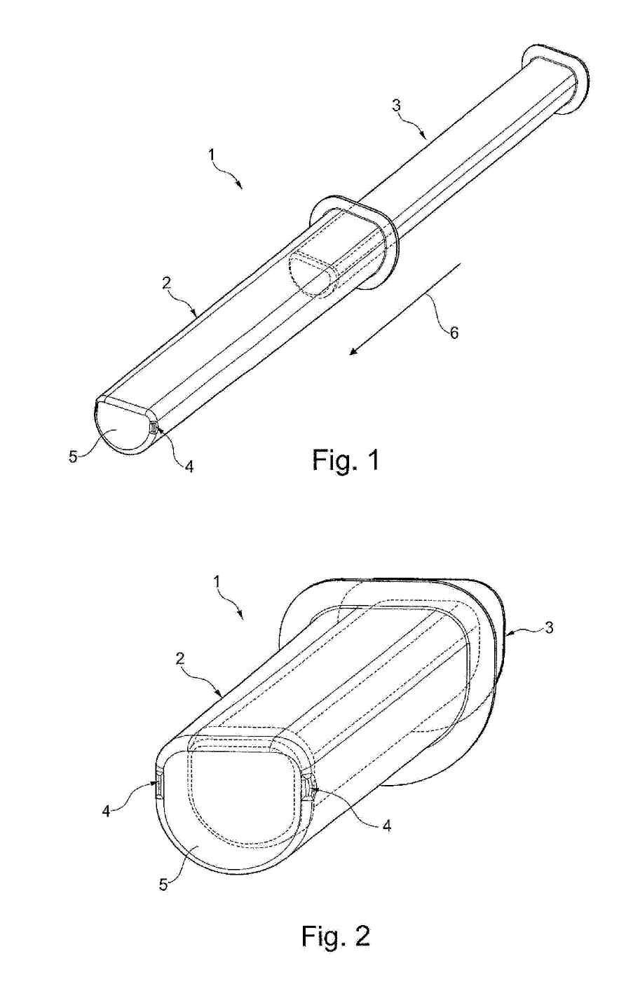

An exemplary construction of a metering pipette 1 according to the invention is shown in FIGS. 1 to 3.

FIG. 1 shows a sleeve 2 forming a chamber for holding a medium, with a plunger 3 is partially inserted by one end thereof in a rear end of the sleeve 2.

At the front end remote from the plunger 3, the sleeve 2 has at least one, preferably exactly two, dispensing openings 4 via which the medium in the sleeve 2 is dispensed when the plunger 3 is pushed into the sleeve 2. Preferably, the at least one dispensing opening 4 is at the front of the sleeve 2 (directly adjacent a front end wall 5 of the sleeve 2), in order for it to be possible to accommodate the largest possible volume of the medium in the sleeve 2. Reference 6 denotes a movement direction of the plunger 3, when it is moved (pushed) into the sleeve 2.

FIG. 2 is a detail view of the front end of the sleeve 2 after the plunger 3 has been completely pressed into the sleeve 2 and the medium has been dispensed from the sleeve 2 via the at least one dispensing opening 4.

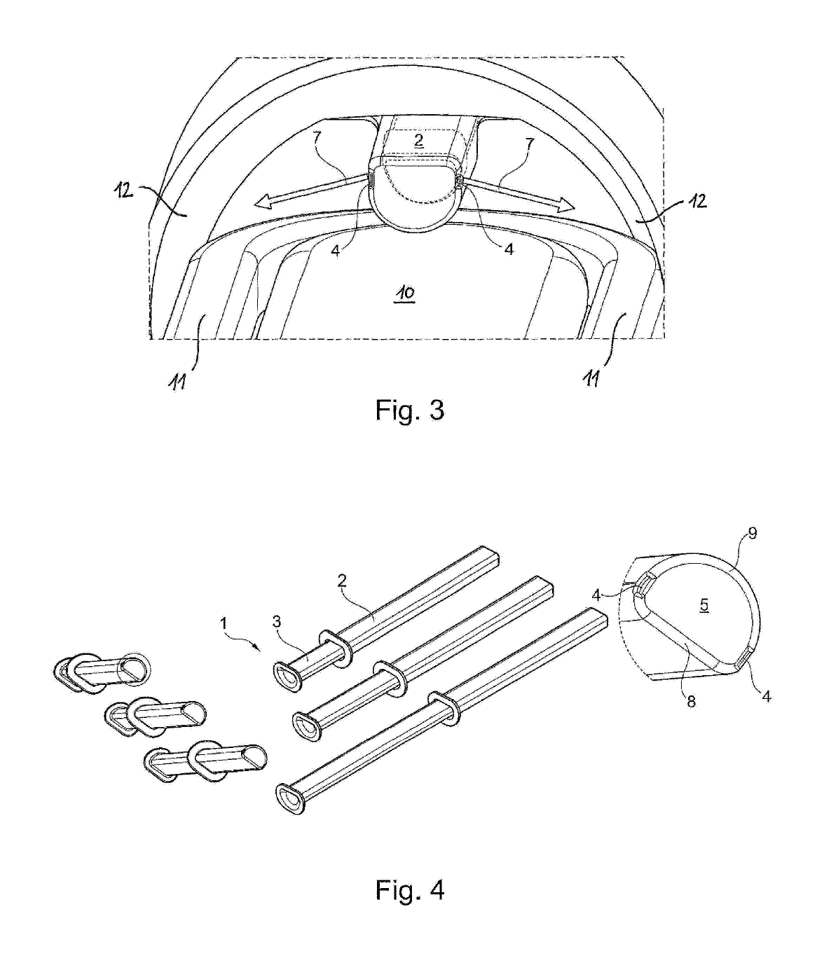

FIG. 3 shows the advantageous effect of the configuration according to the invention of the metering pipette 1. It can be seen that the end of the sleeve 2 having the at least one dispensing opening 4 has been inserted into a mouth. For better illustration, the tongue and the teeth around it are illustrated schematically. The arrows (dispensing direction 7) indicate that the medium is discharged from the sleeve 2 laterally via the at least one dispensing opening (in this case two dispensing openings 4) in the direction of the cheeks, so that this medium cannot pass directly into the pharynx.

The metering pipette 1 is illustrated again, in different views, in FIG. 4. The middle of the view shows the metering pipette with the plunger 3 assuming different positions within the sleeve 2. It can be seen in the bottom region in the middle of FIG. 4 that the plunger 3 fully protrudes from the sleeve 2, with the result that the interior of the sleeve 2 is filled with the medium to be dispensed. The two other views arranged thereabove show that the plunger 3 has been gradually pushed into the sleeve 2 in order for the medium to be dispensed from the interior of the sleeve 2 via the at least one dispensing opening 4. The corresponding illustrations are shown in FIG. 4 on the far left, likewise again from a different view of the metering pipette 1. The illustration on the far right in FIG. 4 illustrates the end wall 5 of the sleeve 2. It can be seen that provision is made of at least one dispensing opening 4, in this case exactly two oppositely situated dispensing openings 4. The end wall 5, and thus the cross section of the sleeve 2, is formed in a half-round and thereby ergonomic manner in such a way that a flat side wall 8 is provided and adjoins an arcuate, preferably semicircular, side wall 9 in a manner adjoining the ends of the flat side wall 8. This geometry is exemplary and can self-evidently be modified.

The cross section, shown in FIGS. 1 to 4 at the front end of the sleeve 2 with the flat side wall 8 and the adjoining arcuate side wall 9 with the exactly two dispensing openings 4 are at the ends of the flat side wall 8 at the transition into the arcuate side wall 9 (see in particular the far-right view in FIG. 4), is particularly important, and is advantageous since the planar surface that is adjoined by the flat side wall 8 constitutes a guide for the insertion of the metering pipette 1 into the mouth, with the result that, for example, the metering pipette 1 can, by way of this planar surface, be placed on the upper side of the tongue in the and opening. Alternatively, the metering pipette 1 can, by way of this planar surface, be placed on the inner side of the upper (or alternatively the lower) palate. In both cases, this ensures that the metering pipette 1 is inserted into the mouth in a positionally correct and targeted manner, above all such that it can no longer be readily rotated, so that, in this way, the two dispensing openings 4 are surely oriented in the correct directions, specifically preferably above the tongue 10 (that is situated between or behind the teeth 11, FIG. 3) in the direction of the cheek inner sides 12, and the dispensing of the medium is likewise in the direction of the cheek inner sides 12 rather than in the direction of the pharynx or the throat. This positionally correct insertion of the metering pipette 1 into the mouth can be seen very clearly in FIG. 3.

List of reference signs

| | |
|---|---|
| 1 | Metering pipette |
| 2 | Sleeve |
| 3 | Plunger |
| 4 | Dispensing opening |
| 5 | End wall |
| 6 | Movement direction |
| 7 | Dispensing direction |
| 8 | Flat side wall |
| 9 | Arcuate side wall |
| 10 | Tongue |
| 11 | Teeth |
| 12 | Cheek inner side |

1. A metering pipette comprising:
a sleeve for holding a medium to be dispensed, and
a plunger longitudinally slidable in the sleeve, at least one dispensing opening for the medium in the sleeve being oriented in the sleeve offset from the longitudinal axis of the sleeve and the longitudinal movement of the plunger, the sleeve being of semicircular cross-sectional shape with a flat side wall and a wall of arcuate section bridging longitudinal edges of the flat side wall.

2. The metering pipette according to claim 1, wherein an end wall of the sleeve is completely closed and the at least one dispensing opening is directly adjacent the end wall.

3. The metering pipette according to claim 2, wherein at least two dispensing openings are in a front end region of the sleeve.

4. The metering pipette according to claim 3, wherein the at least two dispensing openings in the front end region of the sleeve are directly adjacent the end wall.

5. The metering pipette according to claim 3, wherein the at least two dispensing openings are symmetrically positioned in the sleeve.
